(19) United States
(12) Patent Application Publication
(10) Pub. No.: US 2026/0096683 A1
(43) Pub. Date: Apr. 9, 2026

(54) AN APPLIANCE

(71) Applicant: BREVILLE PTY LIMITED, Alexandria, New South Wales (AU)

(72) Inventors: Johnson THIE, Alexandria, New South Wales (AU); Duncan Bruce HELLMERS, Lane Cove (AU); Stephen John MCCLEAN, Camden South (AU)

(21) Appl. No.: 19/112,371

(22) PCT Filed: Sep. 21, 2023
(86) PCT No.: PCT/AU2023/050913

§ 371 Date: Mar. 17, 2025

(30) Foreign Application Priority Data
Sep. 21, 2022 (AU) 2022902732

(51) Int. Cl. A47J 27/212; A47J 27/21

(52) U.S. Cl. CPC A47J 27/212; A47J 27/21191

(57) ABSTRACT

An appliance including: a vessel having a chamber for containing flowable substance; a first sensor arrangement measuring a parameter indicative of the amount of flowable substance in the chamber; wherein, the appliance is configured to determine a target angular deviation from a reference axis required to pour a predetermined amount of flowable substance from the chamber

### FIELD

The present invention relates to an appliance. The appliance, in an embodiment of the present invention, relates to a kettle.

### BACKGROUND

It is often the case that a certain amount of substance is required to be dispensed from an appliance. For example, in the preparation of pour-over coffee or tea, the amount of water added to the grounds greatly affects the properties of the brewed coffee. The flowrate of water added to the grounds in the filter may also affect the quality of the brewed beverage

Gooseneck or pour-over kettles have been developed with an elongate S-shaped spout connecting with a lower portion of the kettle body to provide good control of flowrate in response to tilting the kettle, thereby assisting a user in pouring a desired amount of water.

However, even with the fine control of the pour over kettle it can be difficult to accurately determine the amount of liquid being poured, such that a user instead must rely on means such as a visual assessment or experience and feel, which may lead to inconsistencies in the brewed beverage. To overcome this, a scale may be placed underneath the vessel containing the grounds and filter to gauge the amount of brewed beverage dispensed through said filter. One drawback of this method is the requirement of an additional separate device and that it is not typically useful to measure flowrate, which must be similarly determined by experience and feel or by visual assessment.

It would be desirable to provide an appliance that facilitates a predetermined amount of substance being dispensed. It would also be desirable to provide an appliance that facilitates a predetermined amount of substance being dispensed at a predetermined flowrate.

### SUMMARY

It is an object of preferred embodiments of the invention to address the disadvantages described above and/or to at least provide the public with a useful choice.

In accordance with an aspect of the present invention, there is provided an appliance including: a vessel having a chamber for containing flowable substance; a first sensor arrangement measuring a parameter indicative of the amount of flowable substance in the chamber; wherein, the appliance is configured to determine a target angular deviation from a reference axis required to pour a predetermined amount of flowable substance from the chamber.

In embodiments the appliance further includes a second sensor arrangement measuring a parameter indicative of angular deviation of the vessel from the reference axis.

In embodiments the appliance further includes a feedback actuator to guide the vessel into the target angle based on the measured parameter indicative of the angular deviation.

In embodiments the appliance is a gooseneck kettle.

In embodiments the first sensor is a load cell.

In embodiments the appliance further includes a base for removably receiving the vessel.

In embodiments the load cell is located in the base such that the amount of substance in the chamber may be measured by the load cell when the vessel is removably received by the base.

In embodiments the second sensor arrangement is an IMU.

In embodiments the reference axis is horizontal, such that the second sensor arrangement measures the vessel's tilt from a vertical reference.

In embodiments the chamber has a cylindrical shape.

In embodiments the target tilt (α_{T}) for a predetermined amount yr is calculated from

$$tan ( {α}_{T} ) = \frac{π {R}_{1}^{2} H + {y}_{T} - w ( 0 )}{π {R}_{1}^{2} ( X + {R}_{1} )}$$

where R₁ is the radius of the cylindrical chamber, H is the height of the cylindrical chamber, w(0) is the initial volume of substance determined from the parameter measure by the first sensor arrangement, and X is the horizontal displacement between an inlet and an outlet of a spout of the vessel.

In embodiments the target tilt (α_{T}) is calculated using a search algorithm to solve

$${α}_{T} = arg {min}_{0 < α < 90 °} \vert w ( α ) - w ( {α}_{T} ) \vert$$

where w(α) is the volume of substance in the kettle as a function of tilt (α).

In embodiments the volume of substance in the kettle as a function of tilt is determined by

$$w ( α ) = \{ \begin{matrix}π {R}_{1}^{2} {H}_{w} & , if α \leq {α}_{0} \\ \frac{1}{2} π {R}_{1}^{2} ( {u}_{1} ( α ) + {u}_{2} ( α ) ) & , if {α}_{0} < α < {α}_{1} \\ \frac{1}{2} {u}_{2} ( α ) {R}_{1}^{2} ( π - \frac{1}{2} θ ( α ) + \frac{1}{2} sin ( θ ( α ) ) ) & , otherwise\end{matrix}$$

$$where$$

$${u}_{1} ( α ) = {}^{-} H - ( X + 2 {R}_{1} ) tan ( α )$$

$${u}_{2} ( α ) = H - X tan ( α )$$

$$cos ( \frac{θ ( α )}{2} ) = \frac{H}{{R}_{1} tan ( α )} - \frac{X}{{R}_{1}} - 1$$

$$tan ( {α}_{0} ) = \frac{H - {H}_{w}}{X + {R}_{1}}$$

$$tan ( {α}_{1} ) = \frac{H}{X + 2 {R}_{1}}$$

In embodiments a target tilt rate (dα/dt) for a predetermined flowrate (dy/dt) is calculated from

$$\frac{d α}{d t} = \{ \begin{matrix}\frac{dy}{dt} \frac{{cos}^{2} ( α )}{π {R}_{1}^{2} ( X + {R}_{1} )} , & {α}_{0} < α < {α}_{1} \\ \frac{dy}{dt} \frac{2}{{R}_{1}^{2}} \frac{- 1}{z ( α ) \frac{{du}_{2}}{d α} + {u}_{2} ( α ) \frac{dx}{d α}} , & α > {α}_{1}\end{matrix}$$

$$where$$

$$z ( α ) = π - \frac{1}{2} θ ( α ) + \frac{1}{2} sin ( θ ( α ) )$$

$$\frac{dz}{d α} = \frac{1}{2} \frac{d θ}{d α} ( cos ( θ ( α ) ) - 1 )$$

$$cos ( \frac{θ ( α )}{2} ) = \frac{H}{{R}_{1} tan ( α )} - \frac{X}{{R}_{1}} - 1$$

$$\frac{d θ}{d α} = \frac{2 H}{{R}_{1}} \frac{1}{{sin}^{2} ( α ) \sqrt{1 - {( \frac{H}{{R}_{1} tan ( α )} - \frac{X}{{R}_{1}} - 1 )}^{2}}}$$

$${u}_{2} ( α ) = H - X tan ( α )$$

$$\frac{{du}_{2}}{d α} = \frac{- X}{{cos}^{2} ( α )}$$

In embodiments the chamber has a frustoconical shape, and wherein the target tilt (α_{T}) for a predetermined amount y_{T} is calculated using a search algorithm to solve

$${α}_{0} = arg {min}_{0 < α < α1} \vert w ( α ) - w ( 0 ) \vert$$

$$where$$

$${α}_{1} {tan}^{- 1} ( \frac{H}{X + 2 R} )$$

where w(α) is the volume of substance in the kettle as a function of tilt α, and α₁ is the maximum tilt where a base of the chamber is fully covered by substance.

In embodiments the volume of substance in the kettle as a function of tilt is determined by

$$w ( α ) = \frac{π}{6} \frac{{H}_{o}}{R} ( 2 {R}^{3} - {{r}_{1} ( α )}^{3} - {{r}_{2} ( α )}^{3} )$$

$$where {α}_{0} \leq α \leq {α}_{1} ,$$

$${r}_{1} ( α ) = R - \frac{H - ( X + 2 R ) tan ( α )}{\frac{{H}_{0}}{R} - tan ( α )}$$

$${r}_{2} ( α ) = R - \frac{H - X tan ( α )}{\frac{{H}_{o}}{R} + tan ( α )}$$

$${u}_{1} ( α ) = \frac{H - ( X + 2 R ) tan ( α )}{1 - \frac{R}{{H}_{o}} tan ( α )}$$

$${u}_{2} ( α ) = \frac{H - X tan ( α )}{1 + \frac{R}{{H}_{o}} tan ( α )}$$

$${α}_{1} = {tan}^{- 1} ( \frac{H}{X + 2 R} )$$

$${α}_{0} = arg {min}_{0 \leq α < {α}_{1}} \vert w ( α ) - w ( 0 ) \vert$$

In accordance with an aspect of the present invention, there is provided an appliance including: a vessel having a chamber for containing flowable substance, the vessel including a sensor arrangement for measuring a tilt angle α of the vessel with respect to a reference plane; a base for removably receiving the vessel, the base including a load cell for determining an initial amount of substance w(0) in the vessel received by the base; a control unit that is in electrical communication with the sensor arrangement and the load cell, the control unit being configured to determine a target tilt angle α_{T} required to dispense a user selected amount of substance y_{T} from the chamber based on the initial amount of substance w(0) and the vessel's physical dimensions

In embodiments the appliance further includes an input device in electrical communication with the control unit for selecting the required amount of substance yr to be dispensed from the vessel.

In embodiments the appliance further includes a feedback device for guiding a user to meet the target tilt angle (α_{T}).

In embodiments the feedback device is an electronic display.

In embodiments the feedback device is haptic board.

In embodiments the feedback device is an audio device.

In embodiments the feedback device has an intensity indicative of the deviation of the tilt angle measured by the sensor and the target tilt angle.

In accordance with an aspect of the present invention there is provided a method of using an appliance according to the preceding aspects and embodiments, including the method steps of: measuring the amount of substance in the chamber; selecting a predetermined amount of substance to dispense from the vessel; determining the target tilt angle required to dispense the predetermined amount of substance; orientating the kettle into the target tilt angle and keeping the vessel in this position until substance substantially stops flowing.

### BRIEF DESCRIPTION OF THE DRAWINGS

Preferred embodiments of the invention will now be described, by way of non-limiting example, with reference to the accompanying drawings in which:

FIG. 1 shows a schematic view of a kettle according to an embodiment of the present invention;

FIG. 2 shows a schematic partial view of a kettle according to an embodiment of the present invention;

FIG. 3 shows a schematic partial view of a kettle according to an alternate embodiment of the present invention;

FIG. 4 shows a schematic partial view of a kettle according to an alternate embodiment of the present invention;

FIG. 5 shows an example workflow for operating an embodiment of a kettle according to the present invention;

FIG. 6 shows a schematic representation of an example control system with associated inputs and outputs according to an embodiment of the present invention;

FIG. 7 shows an example operating sequence performed by an embodiment of a kettle according to the present invention;

FIG. 8a shows a schematic view of an embodiment of a kettle according to the present invention in a resting zero-tilt position;

FIG. 8b shows a schematic view of the FIG. 8a kettle tilted slightly with u₂>u₁ but water volume remaining the same;

FIG. 8c shows a schematic view of the FIG. 8b kettle further tilted to do such that water is about to flow from the spout if tilted further;

FIG. 8d shows a schematic view of the FIG. 8c kettle further tilted until u₁=0 in a condition denoted α₁.

FIG. 8e shows a schematic view of the FIG. 8d kettle further tilted such that a base of the chamber/vessel is only partially covered with water, with an insert showing a plan view of the partially covered base of the chamber.

FIG. 9 shows plots of kettle parameters that vary with the tilt angle where the water level is 150 mmm according to the formulations of example 1;

FIG. 10 shows plots of the kettle parameters that vary with tilt angle where the water level is 120 mmm according to the formulations of example 1;

FIG. 11 shows plots of the kettle parameters that vary with tilt angle where the water level is 100 mm according to the formulations of example 1;

FIG. 12 shows plots of the kettle parameters that vary with tilt angle where the water level is 80 mm according to the formulations of example 1;

FIG. 13 shows plots of the kettle parameters that vary with tilt angle where the water level is 40 mm according to the formulations of example 1;

FIG. 14a shows a schematic view of an embodiment of a kettle according to the present invention in a resting zero-tilt position;

FIG. 14b shows a schematic view of the FIG. 14a kettle further tilted to α₀ such that water is about to flow from the spout if tilted further;

FIG. 14c shows a schematic view of the FIG. 14b kettle further tilted until u₁=0 in a condition denoted α_{T} where the waterline just touches the base (r₁=R);

FIG. 15 shows a schematic view of the FIG. 14a kettle tilted to α₀<α<α₁, illustrating the water in he chamber being cast into a first volume which follows the frustrum volume between r₁ and R, while the second volume follows the frustrum volume between r₂ and r₁;

FIG. 16 shows a plot of α₀ found by search algorithm for various initial water volume according to the formulation and example data of example 4;

FIG. 17 shows plots of kettle parameters that vary with tilt angle according to the formulation and example data of example 4.

### DESCRIPTION OF EMBODIMENTS

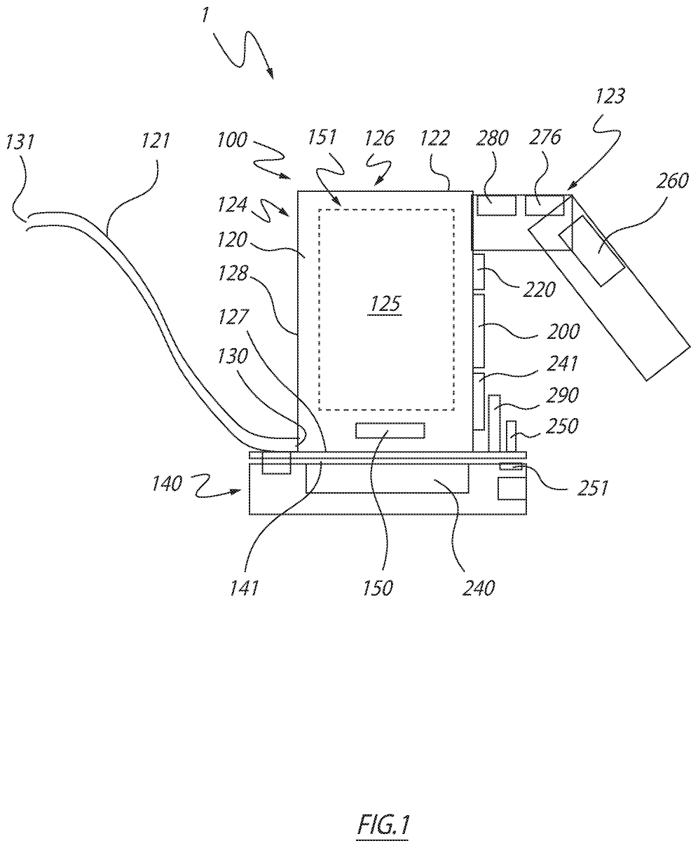

With reference to FIG. 1, shown is an appliance 1 with a vessel 120 to contain a flowable substance to be dispensed from the appliance 1. The embodiment of FIG. 1 is an appliance 1 of the type known as a kettle 100 used to heat a substance, typically water, though other flowable substances can be used. Most commonly, the water is heated to its boiling point and dispensed to prepare beverages such as tea and coffee. However, kettles 100 can be used to heat flowable substances to other temperatures, for example, some consumers prefer certain teas such as green teas to be prepared using water heated to a temperature below its boiling point, such as about 80° C.

The FIG. 1 depiction of the appliance 1 as a kettle 100 is merely an example embodiment of the present invention. In other non-limiting examples, the appliance 1 may be a coffee carafe, a juicer, a blender, or a mixing bowl, or any other appliance 1 with a vessel 120 for containing a flowable substance to be dispensed. The particular form of FIG. 1 is of the type known as a gooseneck or pour-over kettle 100, which may provide good control of the amount of water poured from the spout 121 in response to tilting.

The kettle 100 includes a base 140 on which the vessel 120 is removably located. When the vessel 120 is removably received by the base 140, it may be said to be in its “rest” position. In this rest position with the base 140 positioned on a stable surface such as a kitchen counter or a table, the kettle 100 has a non-tilted or zero-tilt orientation.

The base 140 is a platform on which the vessel 120 can be stably located. The base 140 is connected to a mains power supply via an electrical cable (not shown). The base 140 has a shape that corresponds to a shape of a flat bottom wall portion 127 on an underside of the vessel 120 so as to provide stability to the vessel 120 when the vessel 120 is located thereon. The top surface 141 of the base 140 is substantially flat so as to maximise a surface contact area with the flat bottom wall portion 127 of the vessel 120. Other arrangements are possible, such as corresponding surface features in the base 140 and bottom wall 127, which may help centre the vessel 120 and base 140 when docking and improve docked stability.

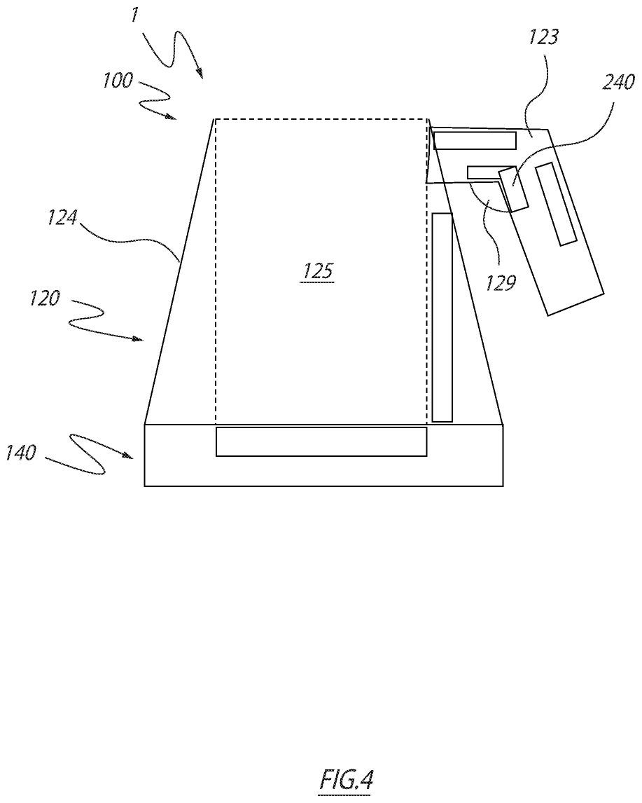

The base 140 may include a mass sensor, such as a load cell 240. The load cell 240 is configured to measure the mass of the kettle 100 when removably received thereby. The signal measured by the load cell 240 may be inputted into the vessel control unit 200 via the physical electrical connection 210. The load cell 240 data signal may then be corrected to account for mass of the vessel 120. The load cell 240 data may also be converted into a parameter representative of the volume of water contained in the chamber 125. A load cell 240 may produce an analogue signal with an ADC 241 used to convert the analogue signal into a digital signal for input into the vessel control unit 200. In the FIG. 1 embodiment, the load cell 240 ADC 241 may be located in the vessel 120, though it may be located within the base 140 or within the load cell 240 unit itself in other embodiments. In embodiments, a temperature sensor (not shown) may output a signal to the vessel control unit 200 allowing temperature correction of the volume parameter. In the embodiment of FIG. 4, a loadcell 240 may be located in the handle 123 and an car 129 provided on the handle 123 to hold/suspend the kettle 100 using the thumb. The weight of the kettle suspended by the thumb equates to the amount of compression weight experienced by the loadcell. Hence, the loadcell measures the volume of the water when it is removed from the base. The loadcell is also used with an ADC to convert its analogue signal into a digital signal for input into the vessel control unit.

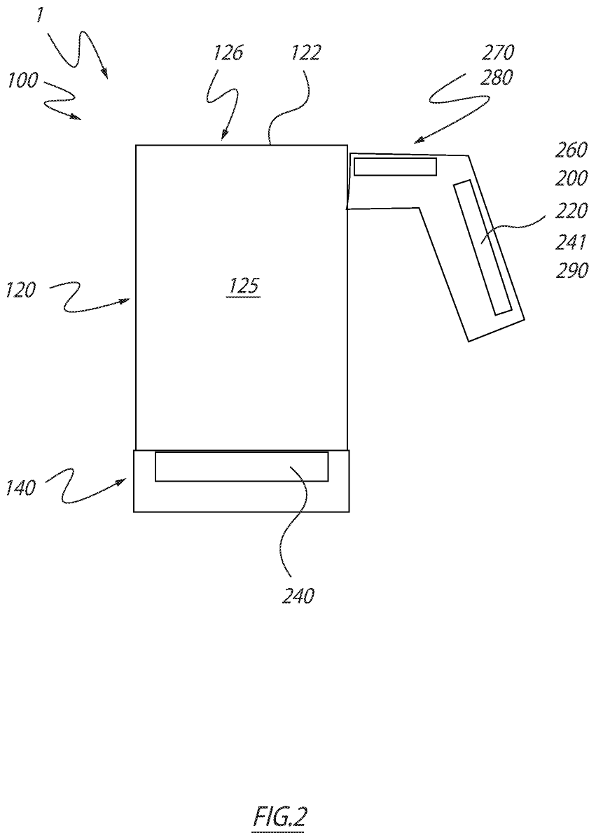

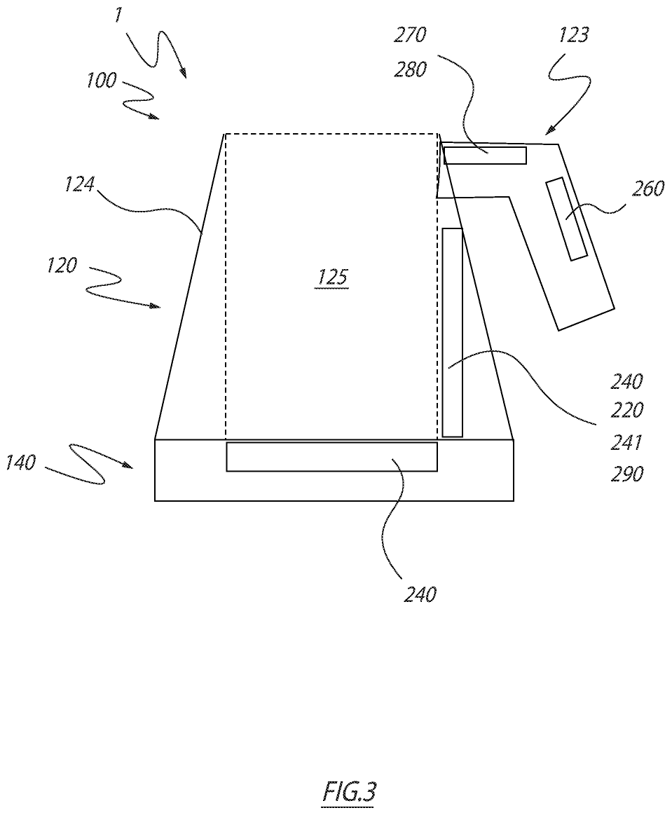

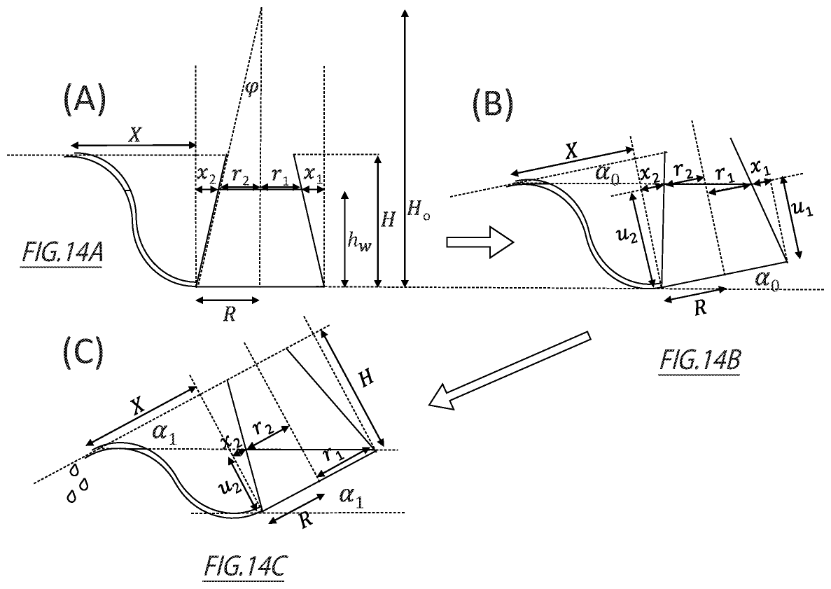

The vessel 120 is a jug or container with a chamber 125 for containing water to be heated. In the embodiment of FIGS. 1 and 2, the vessel 120 has a substantially cylindrical shape, as does its internal chamber 125. In other embodiments, the vessel 120 may have any another volumetric shape. For example, the embodiments of FIGS. 3 and 4 include a frustoconical vessel 120 with a cylindrical internal chamber 125, whereas the embodiments of FIGS. 14a-14c have a frustoconical vessel 120 with a frustoconical internal chamber 125. In other embodiments, the vessel 120 may be spherical with a spherical internal chamber 125, or any suitable desired shape in any desired combination with chamber 125 shape. The vessel 120 has a body 124 having a bottom wall (or floor) portion 127 and side wall portion(s) 128 that extend from the bottom wall portion 127 to define an enclosed volume, or chamber 125, in which water can be contained. The shape of the bottom wall portion 127 corresponds generally to the shape of the base 140 on which the vessel 120 is located.

The vessel 120 has a spout 121 from which water in the vessel 120 can be dispensed. The FIG. 1 embodiment is of a “pour-over” or “goose-neck” kettle 100, and the spout 121 connects with the body 124 of the vessel 120 at a lower portion thereof, said lower portion being that proximal to the base 140 with the kettle 100 in its rest position. The spout 121 may connect with the body 124 at a position closer to the base 140 than the vertical mid-point of the body 124. In embodiments, the spout 121 may connect adjacent to the bottom wall of the body 124, or near adjacent to the bottom wall 127.

The spout 121 has an inlet in communication with the chamber 125 such that the spout 121 may receive water from the chamber 125. The spout 121 defines a passage providing flowable communication between the inlet 130 and an outlet 131 of the spout 121 for dispensing fluid from the vessel 120.

The “goose-neck” style spout 121 of FIG. 1 is elongate and has a generally S-shaped curve. The curvature of the spout 121 may also be described as sigmoid. Starting from the inlet 130, the spout 121 curves upwards until an inflection point along its length whereinafter the spout 121 curves downwards. The inflection point may be at or generally near a midpoint along the length of the spout 121. Other than their direction of curvature, the upwards and downwards portions of the spout 121 may be identical or similarly shaped. The curvatures of the spout 121 and the transition between curvatures may be described as gentle. The curvature of the spout 121 at the outlet 131 may be horizontal or near horizontal. The curvature of the spout 121 at the inlet 130 may also be horizontal or near horizontal

As depicted in FIG. 1, the inlet 130 of the spout 121 may be attached in communication with a lower portion of the chamber 125, such as adjacent or near adjacent to a bottom-most portion of the chamber 125, although other arrangements are possible. As spouts 121 of the goose-neck type span upwards (and outwards) from a bottom portion of the vessel 120 body 124, it is generally preferred to connect the inlet 130 with the chamber 125 at a lower position thereof to maximise the usable volume of the chamber 125 and provide the best control of water dispensing as the vessel 120 is tilted. In FIG. 1, the spout 121 spans upwards with the inlet 130 having a vertical position slightly below the upper most portion of the body 124 (although it has a horizontal position displaced from the body 124.). In other embodiments, the vertical component of the outlets position may be higher than the uppermost part of the body 124, or the same height.

The vessel 120 has a lid 122 which may be adjusted or removed to reveal an opening 126 in the vessel 120 through which water can be provided into the chamber 125. The lid 122 is configured to enclose or partially enclose the opening 126 at the uppermost portion of the chamber 125 when the kettle 100 is being used to heat water.

The vessel 120 has a handle 123 to facilitate manual handling of the vessel 120, including but not limited to lifting the vessel 120 from the base 140, tilting the vessel 120 to pour or dispense a volume of liquid from the chamber 125, and placing the vessel 120 into its rest position on the base 140. The depicted handle 123 of FIG. 1 is generally of the pistol-grip style, however any suitable type of handle 123 may be used. The spout 121 and the handle 123 may be located on opposite sides of the vessel 120, which may facilitate case of dispensing liquid from the spout 121.

The vessel 120 may include a sensor 220 arrangement for measuring a tilt angle of the vessel 120 with respect to a reference plane. The tilt sensor 220 may be positioned on the handle 123, the body 124 or on any other suitable part of the vessel 120. In some embodiments, the vessel control unit 200 may have an integrated tilt sensor 220 for that can be adapted to determine when the vessel 120 is tilted to determine an amount of water in the vessel 120. In other embodiments, the tilt sensor 220 is separate from the control unit 200. The tilt sensor 220 provides a tilt angle of the vessel 120 with respect to the reference plane. The tilt angle sensor 220 is, in an embodiment, pre-programmed with a reference horizontal x-axis and a reference y-axis and is configured to sense when the tilt sensor 220 is displaced or offset from one or both of the reference horizontal x-axis and the reference y-axis. The tilt sensor 220 may be configured to produce a signal indicative of the angular deviation of the vessel 120 from its upright rest position on a horizontal flat stable surface. The angular deviation may be measured in the pouring direction, that is, the degree of angular tilt in a direction toward the spout 121.

The vessel 120 may have a window (151) on a side wall portion 128 thereof through a level of which water contained in the vessel 120 can be viewed. The window preferably spans a substantial height of the vessel 120. The window is generally provided on a sidewall portion of the vessel 120, between the spout 121 and the handle 123. In other embodiments, the window may be provided on a wall portion of the vessel 120 from which the handle 123 extends. In other embodiments, the vessel 120 may not include a window as depicted in FIG. 1.

Based on the amount of water measured in the chamber by the load cell 240, as well as the known physical dimensions of the kettle 100, the kettle 100 is configured to calculate the tilt angle required to dispense a required amount of water. To facilitate this, the kettle 100 may include an input device 270 via which a user selects a required amount of water to dispense, as well as a feedback device guiding the user to orientate the vessel 120 to the required degree of tilt to pour the selected amount of water from the spout 121.

The input device 270 may be located in the handle 123 for convenient operation by the thumb of a user. The input device 270 may include a joystick 270, for example a thumb slide joystick 270, which may be used in conjunction with an electronic display unit. In the embodiment of FIG. 1, the electronic display unit is a TFT screen 280 located on the handle 123 between the joystick 270 and the vessel 120. In an embodiment, the TFT screen 280 may display a number of digits corresponding to a volume to be dispensed and which may be scrolled through using the joystick 270 to select a required amount. In alternative embodiments, the input device 270 may include press button controls, or touch pad controls to select a required volume to dispense.

The vessel control system 200 calculates a target tilt angle for the selected amount of water to be dispensed from the vessel 120 via the spout 121. This calculation is based on the amount of water in the chamber 125 measured by the load cell 240 as well as the known dimensional properties of the kettle 100. The target tilt amount may be displayed on the TFT screen 280 for the user to see.

The vessel 120 may include a feedback actuator 260 to provide a feedback signal to guide the user into orientating the vessel 120 into the target tilt angle to dispense the required amount of water. The feedback signal in particular is a signal that is noticeable by the user. The feedback actuator 260 is configured to provide at least one of an audio output, a tactile output, and a visual output. The feedback actuator 260 may be configured to provide haptic feedback indicative of the angular tilt of the vessel 120 relative to the target tilt. For example, the handle 123 may be provided with a vibration unit that is configured to vibrate at an intensity indicative of the deviation of the kettle 100 from the target value. The vibration unit may be configured to produce a characteristic haptic sensation when the target value is met.

In a non-limiting example, the feedback level outputted by the feedback actuator 260 may have a maximum value when the tilt angle α is greater than the target tilt angle α_{T}, i.e. when the target angle is overshot. When the tilt angle is between the datum non-tilted position and the target, the feedback level may be proportional or inversely proportional to the tilt angle relative the target.

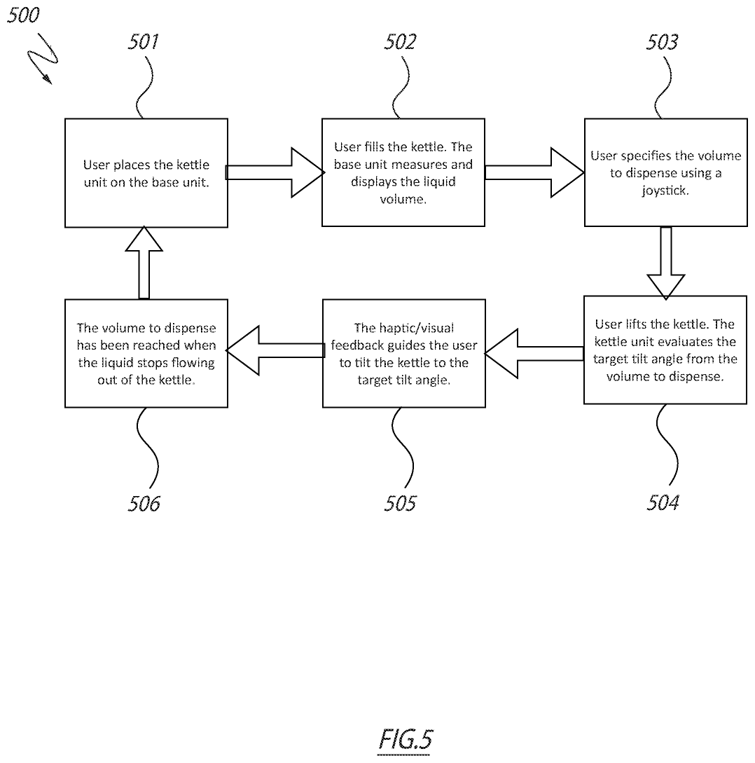

Referring to FIG. 5, shown is a workflow 500 for dispensing a required amount of liquid from the kettle 100 according to an embodiment. At 501 the vessel 120 is to be placed in its rest position removably received by the base 140. At 502, the water is added to the chamber 125 of the kettle 100, with the amount of water being measured by the load cell 240 and optionally displayed on a electric display unit 280 on the base 140 or vessel 120. In alternative embodiments, water can be added to the kettle 100 before placement on the base 140 unit whereupon the amount of water is measured by the load cell 240. At 503, the user selects a required amount of water to dispense from the kettle 100, for example, using the joystick 270 to select a volume displayed on a TFT screen 280. At 504, the vessel control unit 200 determines the target tilt angle required to dispense the selected amount of water allowing the kettle 100 to be lifted from the base 140 and tilted into the target angle under guidance from the feedback actuator 260 at 505. At 506, the kettle 100 is held at the target angle until fluid stops flowing, thereby dispensing the selected amount of water. The user may then replace the vessel 120 on the base 140, thus returning to 501.

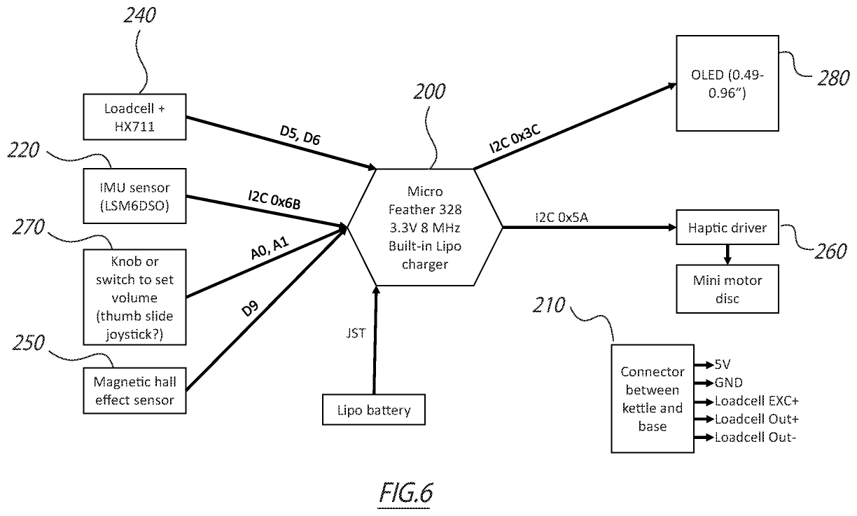

Referring to FIG. 6, shown is an embodiment of the vessel control unit 200 with associated inputs and outputs.

The vessel control unit 200 is in electrical communication with the electrical energy storage component 290 and with the electrically powered devices of the vessel 120, which include the tilt sensor 220, the feedback actuator 260 and the electronic display unit 280 along with any other required devices. The control unit 220 is a computer processor or a microcontroller that is configured to communicate with the electrically powered devices to activate and/or control their operation. The vessel control unit 200 is configured to determine an amount of water in the vessel 120 based on measurements from the load cell 240, calculate a target tilt angle based on this measurement to dispense a user selected amount of water from the vessel 120 and to control an operation of at least one of the electronic display unit 280 and the feedback actuator 260 based on the deviation between the tilt measured by the accelerometer/IMU 220 and the target tilt angle.

The vessel control unit 200 is configured to monitor the charge status or amount of electrical energy stored by the electrical energy storage component 290. The control unit may, in some embodiments, be configured to display the charge status of the electrical energy storage component 290 on the electrical display unit 280.

The vessel control unit 200 is also configured to determine when the vessel 120 is located on the base 140 and when the vessel 120 is removed from the base 140. A docking sensor 250 may be used to detect whether the vessel 120 is connected with the base 140 and to output a signal indicative of this condition to the vessel control unit 200. The docking sensor 250 may be a hall effect sensor 250 located in the vessel 120 configured to detect the presence of a magnet 251 in the base 140 as indicative of the vessel 120 being docked. If the vessel 120 is determined to be on the base 140, the control unit is configured to enable the electrical energy storage component 290 to be charged. When the vessel control unit 200 determines that the vessel 120 is located on the base 140, the vessel control unit 200 may be configured to enable the heating element of the vessel 120 for heating the water contained therein.

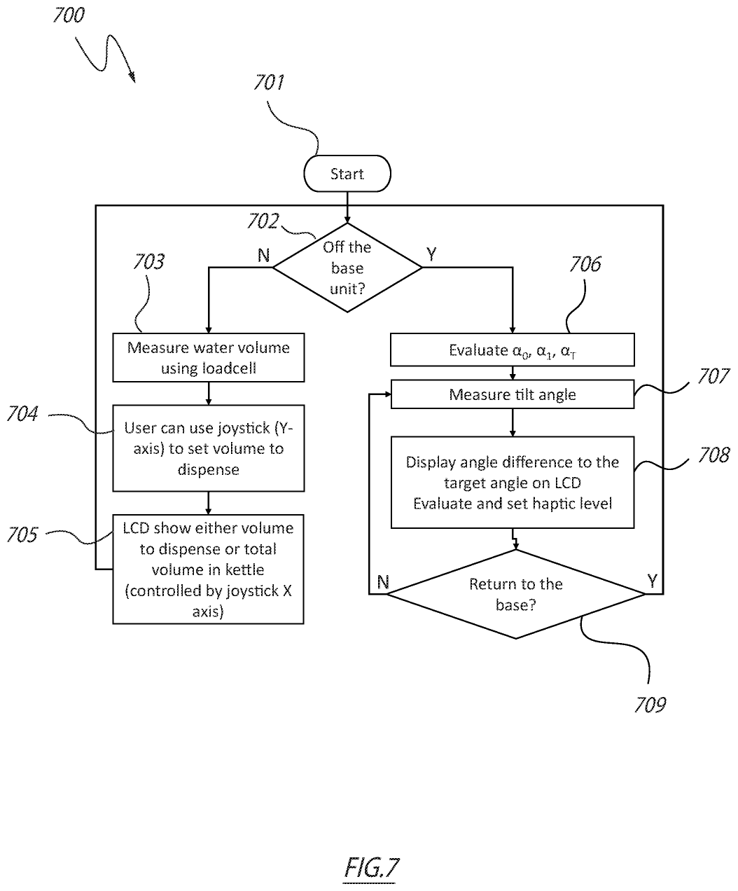

Referring to FIG. 7, shown is a flowchart describing an operational sequence of the vessel control unit 200. Once the sequence is commenced at 701, the vessel control unit 200 determines at 702 whether the vessel 120 is received by the base 140 based on a signal from the hall effect sensor 250.

If the vessel 120 is docked with the base 140, the vessel control unit 200 determines at 703 an amount of water in the chamber 125 based on a signal from the load cell 240. The vessel control unit 200 then determines at 704 the required amount of water to be dispensed based on a user entered selection via the input device 270. At 705, the control unit outputs information to the electronic display unit as selected by the user, for example, the amount of water to be dispensed, or the total amount of water in the chamber 125. The sequence then returns to 702.

If the vessel control unit 200 determines at 702 that the vessel 120 has been lifted from the base 140, the control unit calculates at 706 the target tilt angle α_{T} required to dispense the user selected amount. This calculation is based on the measure amount of water in the chamber 125 as measured by the load cell 240, as well as the known physical dimensions of the vessel 120. The vessel control unit 200 then determines at 707 the current tilt angle based on a signal from the tilt sensor/IMU 220. A feedback signal is then generated to the user at 708 to guide them in orientating the vessel 120 into the target angle. The angular deviation from the target may also be displayed on the electronic display unit 280. If the vessel control unit 200 detects at 709 via the hall effect sensor 250 that the vessel 120 is still removed from the base 140, the sequence returns to 707 to measure the tilt angle and then 708 to generate the feedback signal. If the vessel control unit 200 detects at 709 that the vessel 120 is docked with the base 140, generally following the target angle being met and the selected amount of water being dispensed, the sequence returns to 702.

The vessel 120 has a heating element (150) that is activatable to heat the water in the vessel 120 only when the vessel 120 is centrally located on the base 140. The heating element is centrally located on the bottom wall portion 127 of the vessel 120 in the enclosed volume 125 defined by the vessel 120. The heating element is activated through a physical electrical connected between the base 140 and the vessel 120, the physical connection therebetween being formed when the vessel 120 is located on the base 140. In particular, the base 140 has an electrical-engaging portion that is engageable with an electrical-engaging portion in an underside of the vessel 120 to form a physical electrical connection 210 through which electricity from the base 140 can be provided to the vessel 120 to activate the heating element (and other components requiring power). In these other examples, the electrical-engaging portion in the base 140 may be an upstanding contact portion (e.g. a 3-pole connector or a 5-pole connector) that is engageable with a corresponding electrical port in the underside of the vessel 120. The heating element, in other examples of the present invention, may be activated wirelessly by the base 140. The heating operation of the heating element is controlled by a proportional-integral-derivative (PID) controller. The physical electrical connection may also allow for the transfer of data.

The vessel 120 further contains an electrical energy storage component 290 that is charged when the vessel 120 is located on the base 140 and a plurality of electrically powered devices that are powered by the electrical energy storage component 290. The electrical energy storage component 290 may be a capacitor (e.g. a supercapacitor) or a battery. By having the electrical energy storage device in the vessel 120, the electrically powered devices can be powered and is operable when the vessel 120 is removed from the base 140. These electrically powered devices may also be powered and operable when the vessel 120 is on the base 140.

The kettle 100 may include a sensor 250 measuring a parameter indicative of whether the vessel 120 is docked with the base 140. In the embodiment of FIG. 1, a hall effect sensor 250 on the vessel 120 is used in conjunction with a magnet 251 on the base 140 to determine whether the vessel 120 is in its rest position on the base 140.

In an alternative embodiment, the amount of water in the chamber 125 may be determine by alternative means to the load cell 240. For example, the kettle 100 may have a level sensor which may produce a signal indicative of the amount of water in the chamber 125 based on the known physical properties of the chamber 125. Other non-limiting and non-exhaustive methods to determine the amount of water in the chamber 150 may involve use of metal plates acting as capacitors, interdigitated capacitors, and use of a floating magnet and sensor to translate the detected magnet field to distance.

The plurality of electrically powered devices that are powered by the electrical energy storage component 290 may include an electronic display unit, a sensor arrangement 220, a feedback actuator 260, a hall effect sensor 250, one or more temperature sensors, or any other component as necessary.

The appliance 1 may also be configured to produce a feedback signal to guide the user into orientating the vessel 120 to dispense the user selected amount of water at a user selected flowrate dy/dt. As detailed in a following example, a rate of change in tilt dα/dt from the rest position to the target angle α_{T} can be calculated. The feedback actuator 260 may be used to generate a signal guiding the user whether the need to increase or decrease the rate of tilt, and may provide a further signal instructing the user when the target angle has been reached.

In an embodiment, the kettle 100 may be configured to guide the user into orientating the vessel 120 into the target angle, and to stay at this target angle until water stops flowing completely thereby resulting in the desired amount being dispensed. However, this approach may take a significant amount of time if very accurate results are required as there may be a long convergence to steady state level with water dripping from the spout for a considerable amount of time to dispense the final amount. In an alternative embodiment, the kettle 100 may be configured to guide the user into overshooting the target angle by a certain amount. This certain amount may be selected such that the desired amount of water is dispensed by time the flowrate slows and water starts dripping. In an embodiment, the kettle 100 may guide the user to initially overshoot the target angle by about 2°, and to tilt back to the target angle once the water starts dripping. If the water does not drip at the target angle, the act of pouring the desired amount is finished. Otherwise, the kettle 100 is configured to guide the user to overshoot the target by about 1° until the water stops dripping, whereupon the kettle 100 is tilted back to the target angle to repeat the previous step. The feedback actuator 260 may be configured to produce a feedback signal indicative of when to overshoot and when to throttle back.

### Example 1

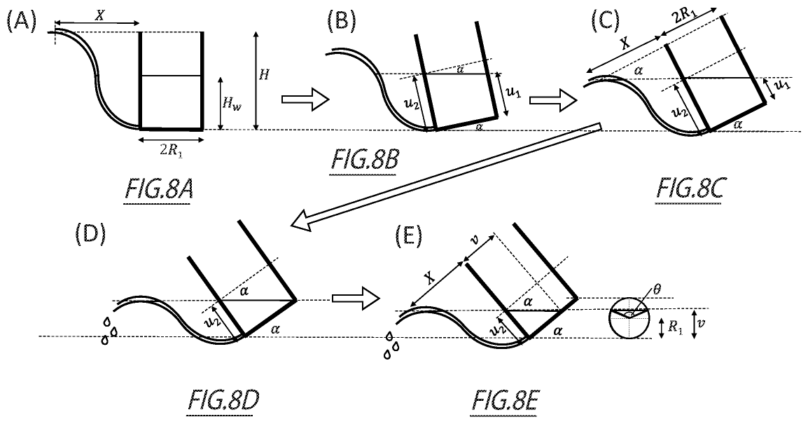

Formulations of water volumes as a function of tilt in a cylindrical gooseneck kettle 100 are made out. FIGS. 8a to 8e show five increasing stages of tilt for a gooseneck kettle 100 with a cylindrical chamber 125. The volume of the spout is assumed to be far less than that of the cylindrical chamber 125, say <1%. When the kettle 100 is tilted and water is flowing out, the water volume in the neck is relatively constant such that the amount of water flowing out is same as the reduced water volume in the kettle body 124. Hence, the water volume in the spout can be deemed negligible.

Let w(α) denote the water volume at a tilt angle, α. Following the assumption that the water volume in the neck is negligible. The volume of water in the kettle 100's body is

$$w ( 0 ) = π {R}_{1}^{2} {H}_{w} \qquad ( 1 )$$

When the kettle 100 is tilted by α without letting any water to flow out, as shown in FIG. 1B, the water volume can also be expressed as

$$w ( α ) = π {R}_{1}^{2} ( \frac{{u}_{1} ( α ) + {u}_{2} ( α )}{2} ) \qquad ( 2 )$$

Substitution of equation (1) into (2) gives

$${u}_{1} ( α ) + {u}_{2} ( α ) = 2 {H}_{w}$$

Combining this relationship with u₂(α)−u₁(α)=2R₁ tan(α) we can solve for u₁ and u₂.

$${u}_{1} ( α ) = {H}_{w} - {R}_{1} tan ( α )$$

$${u}_{2} ( α ) = {H}_{w} + {R}_{1} tan ( α )$$

Let α₀ denote the tilt angle at FIG. 8c where the water is just about to flow out. The water volume is

$$w ( {α}_{0} ) = π {R}_{1}^{2} ( \frac{{u}_{1} ( {a}_{0} ) + {u}_{2} ( {α}_{0} )}{2} ) \qquad ( 3 )$$

$$where$$

$${u}_{2} ( α ) = H - X tan ( α ) \qquad ( 4 )$$

$$and$$

$${u}_{1} ( α ) = H - ( X + 2 {R}_{1} ) tan ( α ) \qquad ( 5 )$$

$$Substituting 5 and 4 into 3$$

$$\frac{{2}_{t} u ( {α}_{0} )}{π {R}_{1}^{2}} = H - ( X + 2 {R}_{1} ) tan ( {α}_{0} ) + H - X tan ( {α}_{0} )$$

$$\frac{w ( {α}_{0} )}{π {R}_{1}^{2}} = H - ( X + {R}_{1} ) ( {α}_{0} )$$

$$tan ( {α}_{0} ) = \frac{H - \frac{w ( {α}_{0} )}{π {R}_{1}^{2}}}{X + {R}_{1}}$$

Since the water volume is still the same as the original, w(α₀)=w(0),

$$tan ( {α}_{0} ) = \frac{H - {H}_{w}}{X + {R}_{1}} \qquad ( 6 )$$

This angle only depends on the fixed parameters of the kettle 100 and water level and so can be determined ahead of time (and thus may be stored in a memory of the vessel 120 control unit).

When the tilt angle exceeds α₀, water starts to flow out of the spout. The water volume of the kettle 100 body 124 can be determined from equation (2) where u₁ and u₂ are given by equations (5) and (4) respectively.

Let α_{T} denote the tilt angle where u₁=0 as shown in FIG. 1D. Then,

$$tan {α}_{1} = \frac{H}{X + 2 {R}_{1}} \qquad ( 7 )$$

Similar to α₀, this angle can be determined ahead of time and stored in a memory of the vessel 120 control unit.

Where the tilt angle exceeds α₁, that water partially covers the base 140 as illustrated in FIG. 8E. The angle, θ, becomes a determining factor to evaluate the area of the base 140, where

$$\begin{matrix}cos ( \frac{θ}{2} ) = \frac{v - {R}_{1}}{{R}_{1}} \\ = \frac{v}{{R}_{1}} - 1\end{matrix}$$

$$where$$

$$tan ( α ) = \frac{H}{v + X}$$

$$v = \frac{H}{tan ( α )} - X$$

Hence, θ is also determined by a

$$cos ( \frac{θ ( α )}{2} ) = \frac{H}{{R}_{1} tan ( α )} - \frac{X}{{R}_{1}} - 1 \qquad ( 8 )$$

The base 140 area is the major segment of the circle, which depends on θ and in turn α.

$$A ( α ) = ( π {R}_{1}^{2} - \frac{1}{2} θ ( α ) {R}_{1}^{2} ) + \frac{1}{2} {R}_{1}^{2} sin ( θ ( α ) ) \qquad ( 9 )$$

Hence the water volume is

$$w ( α ) = \frac{{u}_{2} ( α )}{2} ( π {R}_{1}^{2} - \frac{1}{2} θ ( α ) {R}_{1}^{2} + \frac{1}{2} {R}_{1}^{2} sin ( θ ( α ) ) ) \qquad ( 10 )$$

Where u₂(α) and θ(α) are determined by equations (4) and (8), respectively.

In accordance with the above, the water volume of a gooseneck spout kettle with cylindrical body can be calculated from the tilting angle,

$$w ( α ) = \{ \begin{matrix}π {R}_{1}^{2} {H}_{w} , & if α \leq {α}_{0} \\ \frac{1}{2} π {R}_{1}^{2} ( {u}_{1} ( α ) + {u}_{2} ( α ) ) , & if {α}_{0} < α \leq {α}_{1} \\ \frac{1}{2} {u}_{2} ( α ) {R}_{1}^{2} ( π - \frac{1}{2} θ ( α ) + \frac{1}{2} sin ( θ ( α ) ) ) , & otherwise\end{matrix} \qquad ( 11 )$$

$$where$$

$${u}_{1} ( α ) = H - ( X + 2 {R}_{1} ) tan ( α )$$

$${u}_{2} ( α ) = H - X tan ( α )$$

$$cos ( \frac{θ ( α )}{2} ) = \frac{H}{{R}_{1} tan ( α )} - \frac{X}{{R}_{1}} - 1$$

$$tan ( {α}_{0} ) = \frac{H - {H}_{w}}{X + {R}_{1}}$$

$$tan ( {α}_{1} ) = \frac{H}{X + 2 {R}_{1}}$$

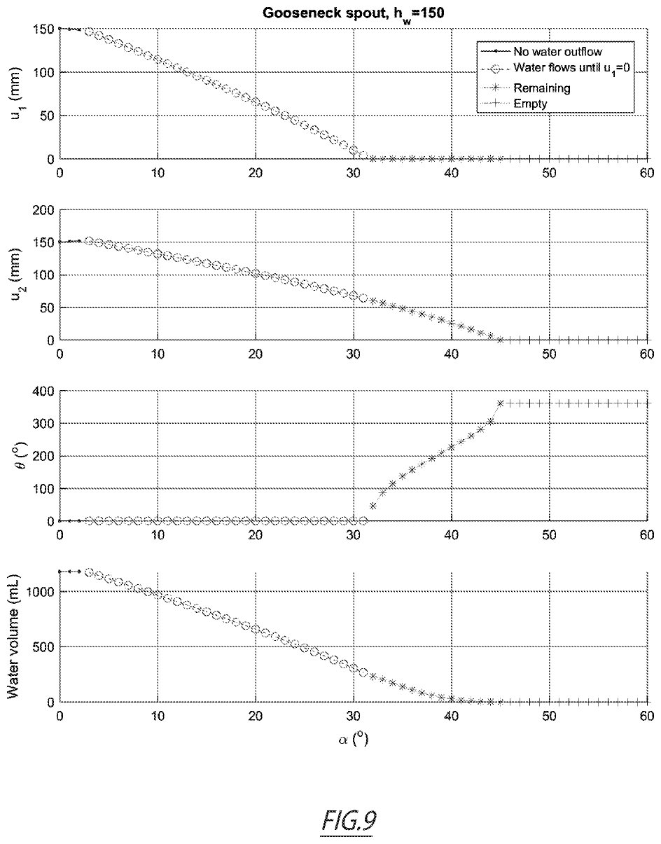

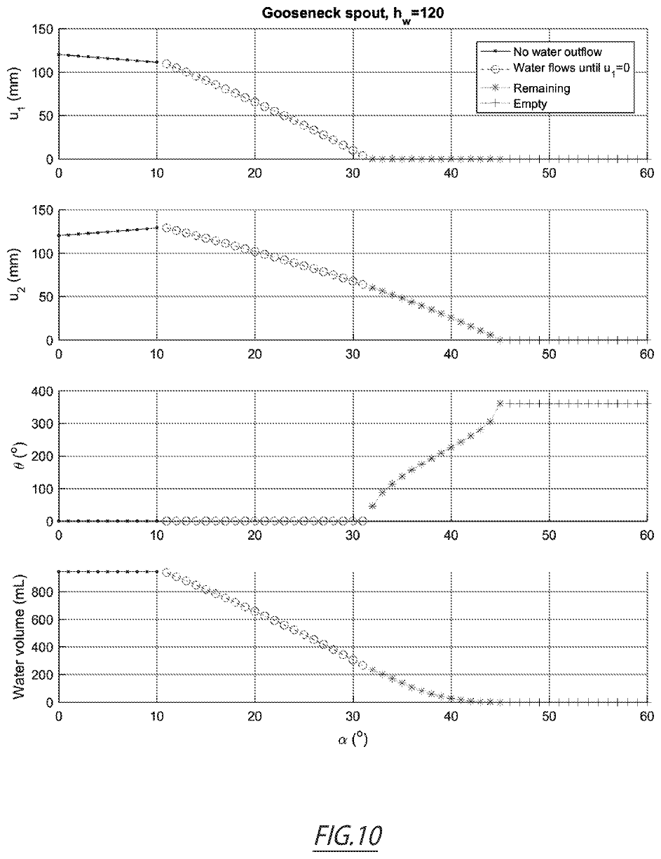

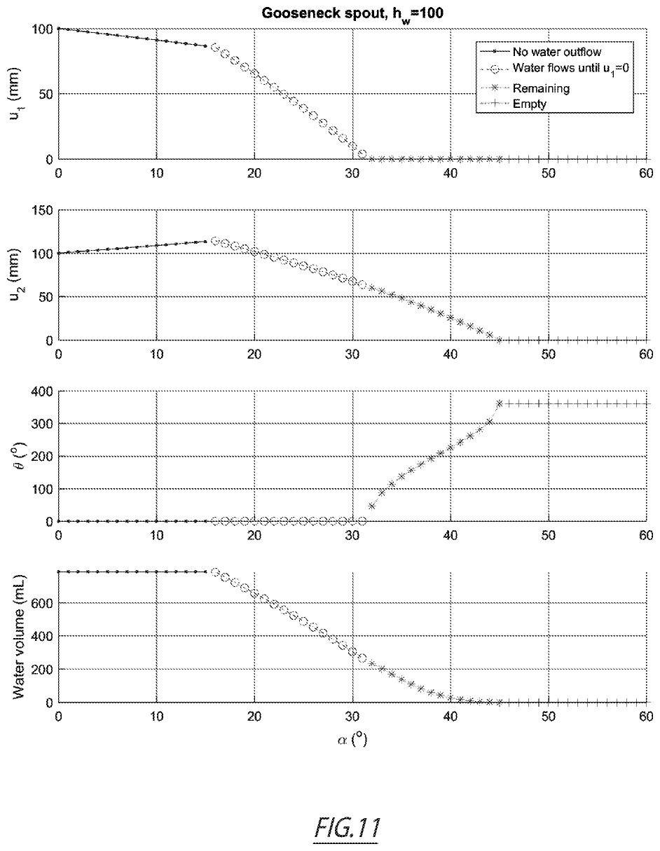

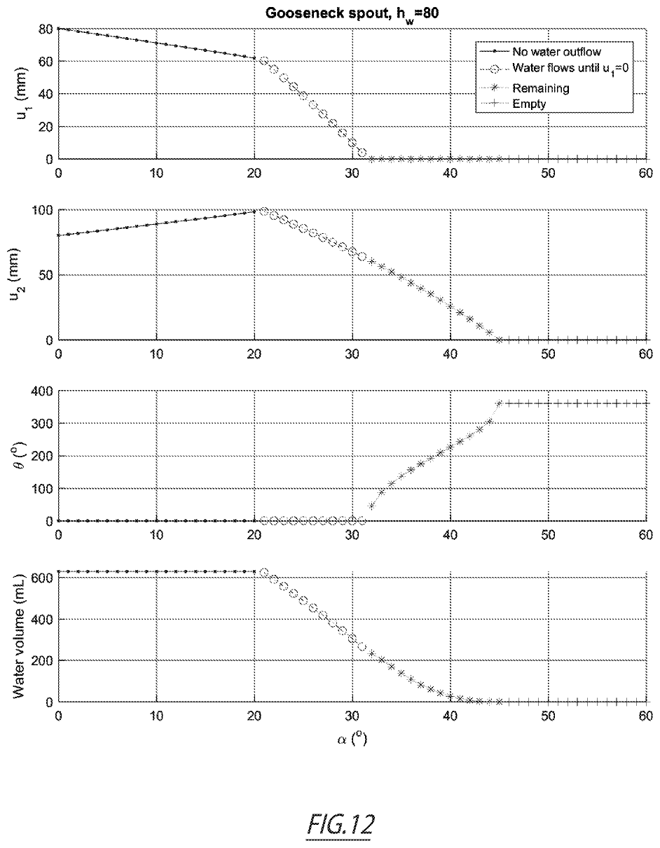

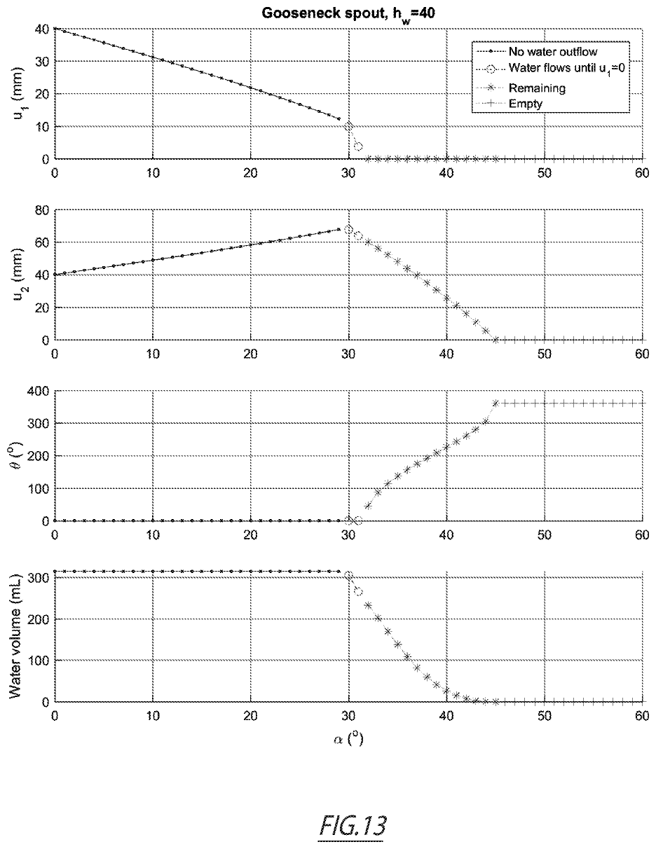

This formulation was verified using Matlab with H=160 mm, R₁=50 mm and X=160 mm. The water volume was evaluated for 0°≤α≤60° given various H_{w}. FIGS. 9 to 13 show the water volume and parameters.

### Example 2

The water volume formulation of FIG. 8 may be used to determine a target tilt angle for a gooseneck kettle 100 to deliver a selected amount of water. Let y(α)=w(0)−w(α) denote the water poured out of the kettle 100 where w(0) is the initial water volume before pouring. Suppose that we wish to pour a specified total volume of water, y_{T}. Then

$${y}_{T} = w ( 0 ) - w ( {α}_{T} ) \qquad ( 12 )$$

$$w ( {a}_{T} ) = w ( 0 ) - {y}_{T} \qquad ( 13 )$$

The formulation can be solved to find the target angle α_{T} by performing a search algorithm for 0<α<90° where |w(α)−w(α_{T})| is minimised. This algorithm is guaranteed to work since w(α) decreases monotonically as α increase, that is,

$${α}_{T} = arg {min}_{0 < α < 90 °} \vert w ( α ) - w ( {α}_{T} ) \vert \qquad ( 14 )$$

It is also possible to analytically solve for α_{T} where α≤α₁. The water volume expression can be re-arranged to

$$\begin{matrix}w ( α ) = \frac{1}{2} π {R}_{1}^{2} ( H - ( X + 2 {R}_{1} ) tan ( α ) + H - X tan ( α ) ) \\ = \frac{1}{2} π {R}_{1}^{2} ( 2 H - ( 2 X + 2 {R}_{1} ) tan ( α ) ) \\ = π {R}_{1}^{2} ( H - ( X + {R}_{1} ) tan ( α ) )\end{matrix}$$

$$\frac{w ( α )}{π {R}_{1}^{2}} = H - ( X + {R}_{1} ) tan ( α )$$

$$\begin{matrix}tan ( α ) = \frac{H - \frac{w ( α )}{π {R}_{1}^{2}}}{X + {R}_{1}} \\ = \frac{π {R}_{1}^{2} H - w ( α )}{π {R}_{1}^{2} ( X + {R}_{1} )}\end{matrix}$$

Substituting equation (13) to w(α),

$$\begin{matrix}tan ( {α}_{T} ) = \frac{π {R}_{1}^{2} H - w ( {α}_{T} )}{π {R}_{1}^{2} ( X + {R}_{1} )} \\ = \frac{π {R}_{1}^{2} H - ( w ( 0 ) - {y}_{T} )}{π R ( X + {R}_{1} )}\end{matrix}$$

$$tan ( {α}_{T} ) = \frac{π {R}_{1}^{2} H + {y}_{T} - w ( 0 )}{π {R}_{1}^{2} ( X + {R}_{1} )} \qquad ( 15 )$$

### Example 3

For where α>α₁, w(α) may be best solved algorithmically due to additional complexity in rearranging. Alternatively, it may be more convenient to use a look-up table that correlates water volume to tilt angle, with said table being stored in the microcontroller's permanent storage. Due to the complexity when α>α₁, it may be convenient to exclude this case from the overall system if possible if the functional impact on the kettle 100 is insubstantial. One condition where this may be the case is when w(α₁) is small enough that a user would likely not tilt the kettle 100 beyond α₁.

When the tilt angle is α₁, u₁(α₁)=0. Then,

$$0 = H - ( X + 2 {R}_{1} ) tan ( {α}_{1} )$$

$$tan ( {α}_{1} ) = \frac{H}{X + 2 {R}_{1}}$$

$$and$$

$$\begin{matrix}w ( {α}_{1} ) = \frac{1}{2} π {R}_{1}^{2} ( 0 + {u}_{2} ( {α}_{1} ) ) \\ = \frac{1}{2} π {R}_{1}^{2} ( H - X tan ( {α}_{1} ) ) \\ = \frac{1}{2} π {R}_{1}^{2} ( H - X \frac{H}{X + 2 {R}_{1}} ) \\ = \frac{1}{2} π {R}_{1}^{1} ( H - \frac{H}{1 + 2 \frac{{R}_{1}}{X}} )\end{matrix}$$

Therefore, w(α1) is minimised when R₁<<X.

For example, given H=155, R₁=40, X=175, H_{w}=100,

$$\begin{matrix}w ( 0 ) = π {R}_{1}^{2} {H}_{w} \\ = 502 mL\end{matrix}$$

$$w ( {α}_{1} ) = 122 mL$$

The volume at α₁ is only a half metric cup and 25% of the initial volume. Accordingly, a user would likely consider this amount insufficient to prepare a beverage and would likely seek to refill a kettle 100 in this condition rather than seek to accurately dispense some proportion of the remaining water volume.

### Example 4

We may also wish to pour the water at a specified flow rate, dy/dt. Then, we need to find the relationship between the flowrate and the tilt angle rate, dα/dx.

To solve for dα/dt, we take the first order derivative of y(α).

$$\frac{dy}{d α} = - \frac{dw}{d α}$$

$$\frac{dy}{dt} \frac{dt}{d α} = - \frac{dw}{d α}$$

$$\frac{d α}{dt} = - \frac{dy}{dt} \frac{d α}{dw}$$

where dy/dt is a specified constant and dα/dw can be derived from equation (11).

From equation (11),

$$\frac{dw}{d α} = \frac{1}{2} π {R}_{1}^{2} ( \frac{{du}_{1}}{d α} + \frac{{du}_{2}}{d α} )$$

for α₀<α≤α₁, where

$$\frac{{du}_{1}}{d α} = \frac{- ( X + 2 {R}_{1} )}{{cos}^{2} ( α )} \qquad ( 16 )$$

$$\frac{{du}_{2}}{d α} = \frac{- X}{{cos}^{2} ( α )} \qquad ( 17 )$$

$$Then ,$$

$$\frac{dw}{d α} = \frac{- π {R}_{1}^{2} ( X + {R}_{1} )}{{cos}^{2} ( α )} \qquad ( 18 )$$

Substituting equation (18) to (16),

$$\frac{d α}{d t} = \frac{dy}{dt} \frac{{cos}^{2} ( α )}{π {R}_{1}^{2} ( X + {R}_{1} )} \qquad ( 19 )$$

Similarly, from equation (11) for α>α₁,

$$w ( α ) = \frac{{R}_{1}^{2}}{2} {u}_{2} ( α ) z ( α )$$

$$where$$

$$z ( α ) = π - \frac{1}{2} θ ( α ) + \frac{1}{2} sin ( θ ( α ) )$$

$$Then ,$$

$$\frac{dw}{d α} = \frac{{R}_{1}^{2}}{2} ( z ( α ) \frac{d {u}_{2}}{d α} + {u}_{2} ( α ) \frac{dz}{d α} )$$

$$where \frac{{du}_{2}}{d α} is defined in ( 17 ) and \frac{d z}{d α} = \frac{1}{2} \frac{d θ}{d α} ( cos ( θ ( a ) ) - 1 )$$

From equation (11), taking the first derivative of cos(θ/2),

$$- sin ( \frac{θ}{2} ) \frac{1}{2} \frac{d θ}{d α} = \frac{H}{R} \frac{- 1}{{sin}^{2} ( α )}$$

$$\frac{d θ}{d α} = \frac{2 H}{R} \frac{1}{{sin}^{2} ( α )} \frac{1}{sin ( \frac{θ}{2} )}$$

$$Since {sin}^{2} ( \frac{θ}{2} ) = 1 - {cos}^{2} ( \frac{θ}{2} ) , \\ \frac{d θ}{d α} = \frac{2 H}{{R}_{1}} \frac{1}{{sin}^{2} ( α ) \sqrt{1 - {( \frac{H}{{R}_{1} tan ( α )} - \frac{X}{{R}_{1}} - 1 )}^{2}}} \qquad ( 20 )$$

Accordingly, in order to pour a specified volume of water, y_{T}, out of the kettle 100 at a specified rate, dy/dt, the kettle 100 must be tilted to α_{T} at a rate of dα/dt. If α_{T}<α₁,

$${α}_{T} = arctan ( \frac{π {R}_{1}^{2} H + {y}_{T} - w ( 0 )}{π {R}_{1}^{2} ( X + {R}_{1} )} ) \qquad ( 21 )$$

Alternatively, α_{T} can be found wing a march algorithms,

$${α}_{T} = arg {min}_{0 < α < 90 °} \vert w ( α ) - w ( {α}_{T} ) \vert$$

where w=(α) is defined in equation (11) and w(α_{T})=w(0)−y_{T}. And dα/dt can be evaluated from

$$\frac{d α}{dt} = \{ \begin{matrix}\frac{dy}{dt} \frac{{cos}^{2} ( α )}{π {R}_{1}^{2} ( X + {R}_{1} )} , & {α}_{0} < α \leq {α}_{1} \\ \frac{dy}{dt} \frac{2}{{R}_{1}^{2}} \frac{- 1}{x ( α ) \frac{d {u}_{2}}{d α} + {u}_{2} ( α ) \frac{dx}{d α}} , & α > {α}_{1}\end{matrix} \qquad ( 22 )$$

$$where$$

$$z ( α ) = π - \frac{1}{2} θ ( α ) + \frac{1}{2} sin ( θ ( α ) )$$

$$\frac{d z}{d α} = \frac{1}{2} \frac{d θ}{d α} ( cos ( θ ( α ) ) - 1 )$$

$$cos ( \frac{θ ( α )}{2} ) = \frac{H}{{R}_{1} tan ( α )} - \frac{X}{{R}_{1}} - 1$$

$$\frac{d θ}{d α} = \frac{2 H}{{R}_{1}} \frac{1}{{sin}^{2} ( α ) \sqrt{1 - {( \frac{H}{{R}_{1} tan ( α )} - \frac{X}{{R}_{1}} - 1 )}^{2}}}$$

$${u}_{2} ( α ) = H - X tan ( α )$$

$$\frac{{du}_{2}}{d α} = \frac{- X}{{cos}^{2} ( α )}$$

### Example 4

This section considers extending the formulation for the cylindrical kettle to the conical frustrum shape commonly seen in kettles.

FIGS. 14a to 14b shows a conical frustrum kettle 100 at three positions, namely, (A) resting position, (B) tilted to α₀ such that the water is about to flow out and (C) tilted to α₁ such that the water line has reached the base and so u₁=0.

The water volume when the water level is at h_{w} is

$$w ( 0 ) = \frac{π}{3} {R}^{2} {H}_{0} - \frac{π}{3} {r}_{1}^{2} ( {H}_{0} - {h}_{w} ) \qquad ( 23 )$$

H_{w} can be expressed as a function of r₁. As shown in FIG. 14a,

$$tan ϕ = \frac{R}{{H}_{0}} = \frac{{r}_{1}}{{H}_{o} - {h}_{w}}$$

$$R ( {H}_{0} - {h}_{w} ) = {H}_{o} {r}_{1}$$

$${RH}_{0} - R {h}_{w} = {H}_{o} {r}_{1}$$

$${h}_{w} = {H}_{o} - \frac{{H}_{o}}{R} {r}_{w}$$

Hence the water volume becomes

$$w ( 0 ) = \frac{π}{3} {H}_{o} ( {R}^{2} - \frac{{r}_{w}^{3}}{R} ) \qquad ( 24 )$$

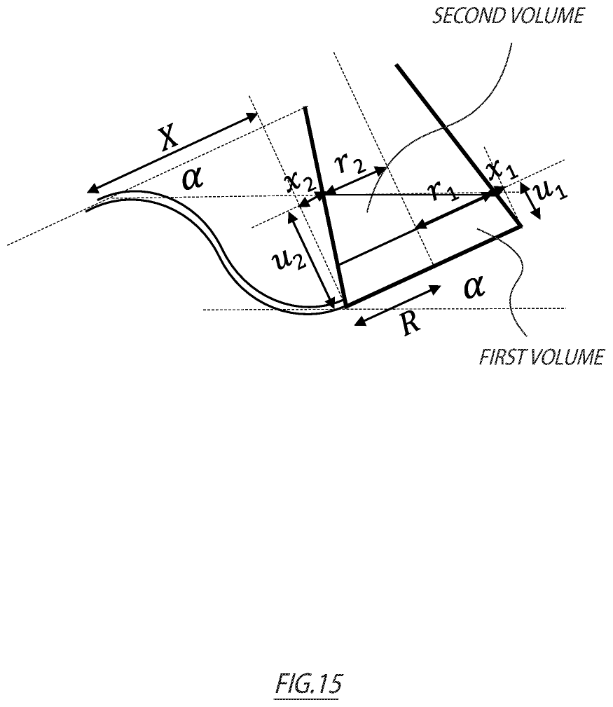

When α≥α₀, the water volume is the sum of the of the first volume and second volume shown in FIG. 15. Let w₁(α) and w₂(α) denote the conical frustrum volume below r₁(α) and r₂(α), respectively. That is,

$${w}_{1} ( α ) = \frac{π}{3} {H}_{o} ( {R}^{2} - \frac{{{r}_{1} ( α )}^{3}}{R} ) \qquad ( 25 )$$

$${w}_{2} ( α ) = \frac{π}{3} {H}_{o} ( {R}^{2} - \frac{{{r}_{2} ( α )}^{3}}{R} ) \qquad ( 26 )$$

Now,

$$\frac{{x}_{2}}{{u}_{2}} = \frac{R}{{H}_{o}}$$

$$\frac{R - {r}_{2}}{{u}_{2}} = \frac{R}{{H}_{o}}$$

$${H}_{o} R - {H}_{o} {r}_{2} = R {u}_{2}$$

$${r}_{2} = R - \frac{R}{{H}_{o}} {u}_{2}$$

Similarly,

$${r}_{1} = R - \frac{R}{{H}_{o}} {u}_{1}$$

$$Since {r}_{1} + {x}_{1} = R and {r}_{2} + {x}_{2} = R ,$$

$${x}_{1} = \frac{R}{{H}_{o}} {u}_{1}$$

$${x}_{2} = \frac{R}{{H}_{o}} {u}_{2}$$

In addition,

$$\begin{matrix}tan ( α ) = \frac{H - {u}_{2} ( α )}{X + {x}_{2} ( α )} \\ = \frac{H - {u}_{2} ( α )}{X + \frac{R}{{H}_{o}} {u}_{2} ( α )}\end{matrix}$$

$$X tan ( α ) + \frac{R}{{H}_{o}} {u}_{2} ( α ) tan ( α ) = H - {u}_{2} ( α )$$

$$\frac{R}{{H}_{o}} {u}_{2} ( α ) tan ( α ) + {u}_{2} ( α ) = H - X tan ( α )$$

$${u}_{2} ( α ) ( 1 + \frac{R}{{H}_{o}} tan ( α ) ) = H - X tan ( α )$$

$${u}_{2} ( α ) = \frac{H - X tan ( α )}{1 + \frac{R}{{H}_{o}} tan ( α )}$$

$$and$$

$$tan ( α ) = \frac{H - {u}_{1} ( α )}{X + 2 R - {x}_{1} ( α )}$$

$${u}_{1} ( α ) = \frac{H - ( X + 2 R ) tan ( α )}{1 - \frac{R}{{H}_{o}} tan ( α )}$$

Then, the water volume is

$$\begin{matrix}w ( α ) = {w}_{1} ( α ) + \frac{1}{2} ( {w}_{2} ( α ) - {w}_{1} ( α ) ) \\ = \frac{1}{2} ( {w}_{1} ( α ) + {w}_{2} ( α ) ) \\ = \frac{1}{2} ( \frac{π}{3} {H}_{o} ( {R}^{2} - \frac{{{r}_{1} ( α )}^{3}}{R} ) + \frac{π}{3} {H}_{o} ( {R}^{2} - \frac{{{r}_{2} ( a )}^{3}}{R} ) ) \\ = \frac{π}{6} {H}_{o} ( 2 {R}^{2} - \frac{{{r}_{1} ( α )}^{3}}{R} - \frac{{{r}_{2} ( α )}^{3}}{R} ) \\ = \frac{π}{6} \frac{{H}_{o}}{R} ( 2 {R}^{3} - {{r}_{1} ( α )}^{3} - {{r}_{2} ( α )}^{3} )\end{matrix}$$

where r₁ and r₂ are re-arranged to

$$\begin{matrix}{r}_{1} ( α ) = R - \frac{R}{{H}_{o}} ( \frac{H - ( X + 2 R ) tan ( α )}{1 - \frac{R}{{H}_{o}} - tan ( α )} ) \\ = R - \frac{H - ( X + 2 R ) tan ( α )}{\frac{{H}_{o}}{R} - tan ( α )}\end{matrix}$$

$$and$$

$$\begin{matrix}{r}_{2} ( α ) = R - \frac{R}{{H}_{o}} ( \frac{H - X tan ( α )}{1 + \frac{R}{{H}_{o}} tan ( α )} ) \\ = R - \frac{H - X - tan ( α )}{\frac{{H}_{o}}{R} + tan ( α )}\end{matrix}$$

Given the complexity of the water volume expression, it may be convenient to find α₀ using a search algorithm.

$${α}_{0} = arg {min}_{0 < α < {α}_{1}} \vert w ( α ) - w ( 0 ) \vert$$

$$where$$

$${α}_{1} = {tan}^{- 1} ( \frac{H}{X + 2 R} )$$

In summary, the water volume of a conical frustrum kettle is

$$w ( α ) = \frac{π}{6} \frac{{H}_{o}}{R} ( 2 {R}^{3} - {{r}_{1} ( α )}^{3} - {{r}_{2} ( α )}^{3} ) \qquad ( 27 )$$

$$where {α}_{0} \leq α \leq {α}_{1} ,$$

$${r}_{1} ( α ) = R - \frac{H - ( X + 2 R ) tan ( α )}{\frac{{H}_{o}}{R} - tan ( α )} \qquad ( 28 )$$

$${r}_{2} ( α ) = R - \frac{H - X tan ( α )}{\frac{{H}_{o}}{R} + tan ( α )} \qquad ( 29 )$$

$${u}_{1} ( α ) = \frac{H - ( X + 2 R ) tan ( α )}{1 - \frac{R}{{H}_{o}} tan ( α )} \qquad ( 30 )$$

$${u}_{2} ( α ) = \frac{H - X tan ( α )}{1 + \frac{R}{{H}_{o}} tan ( α )} \qquad ( 31 )$$

$${α}_{1} = {tan}^{- 1} ( \frac{H}{X + 2 R} ) \qquad ( 32 )$$

$${α}_{0} = arg {min}_{0 \leq α < {α}_{1}} \vert w ( α ) - w ( 0 ) \vert \qquad ( 33 )$$

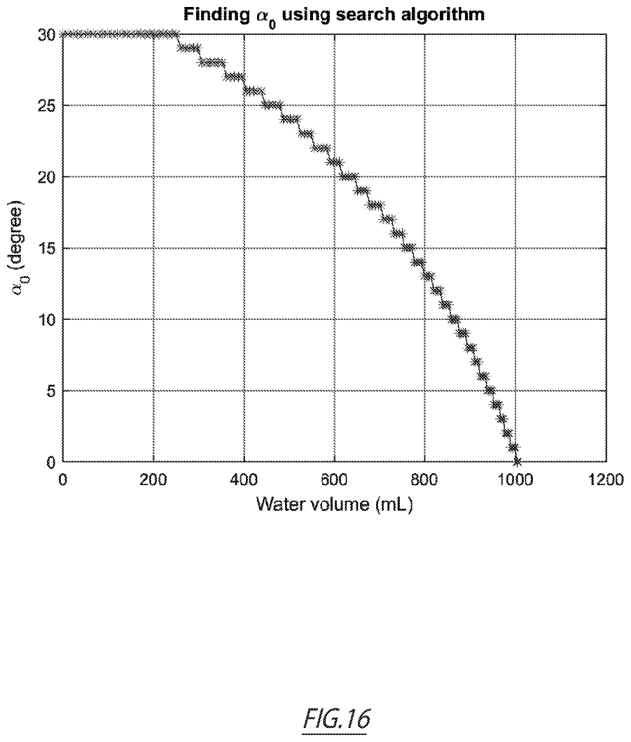

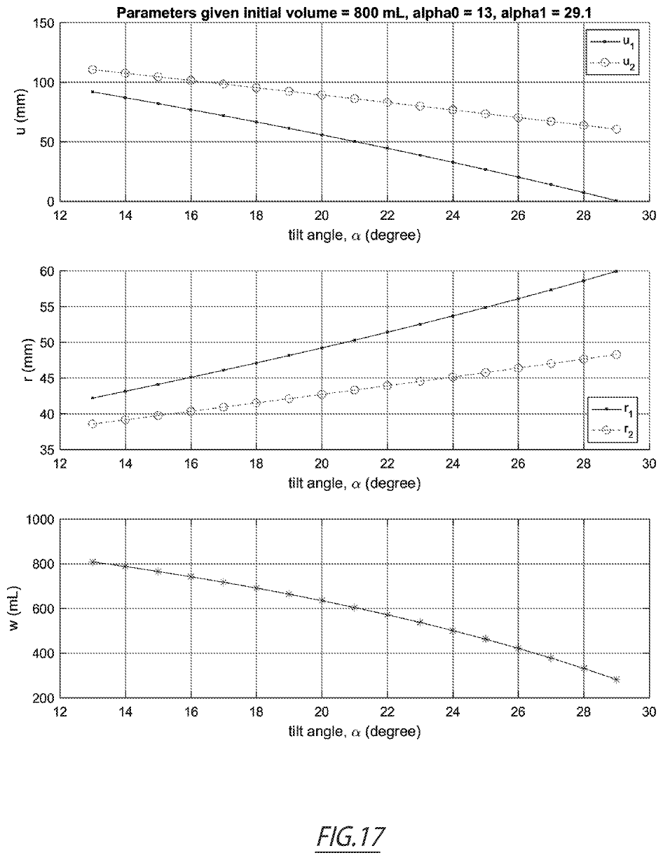

As an example, FIG. 16 shows corresponding α₀ for various water volumes given H=150, R=60, Hₒ=309, X=150 mm, respectively. FIG. 17 shows the parameters u, r and water volume for α₀≤α<α₁, when the initial water volume is 800 ml (and so the α₀=13°).

The various embodiments of the present invention described above have been presented by way of example only, and not by way of limitation. It will be apparent to a person skilled in the relevant art that various changes in form and detail can be made therein without departing from the spirit and scope of the invention. The present invention should not be limited by any of the exemplary embodiments described above.

### PARTS LIST

1 appliance
100 kettle
120 vessel
121 spout
122 lid
123 handle
124 vessel body
125 chamber
126 opening in chamber
127 bottom wall portion
128 side wall
129 ear
130 inlet
131 outlet
140 base
141 top surface
150 heating element
151 window
200 vessel control unit
210 electrical connection
220 tilt sensor/accelerometer/IMU
240 load cell
241 ADC
250 docking sensor/hall effect sensor
251 magnet
260 feedback actuator
270 input device/joystick
280 electric display unit/TFT screen
290 electrical energy storage component (battery)

1. An appliance including:
a vessel having a chamber for containing flowable substance;
a first sensor arrangement measuring a parameter indicative of the amount of flowable substance in the chamber; wherein,
the appliance is configured to determine a target angular deviation from a reference axis required to pour a predetermined amount of flowable substance from the chamber.

2. The appliance according to claim 1, further including a second sensor arrangement measuring a parameter indicative of angular deviation of the vessel from the reference axis.

3. The appliance according to claim 1 or 2, further including a feedback actuator to guide the vessel into the target angle based on the measured parameter indicative of the angular deviation.

4. The appliance according to any one of the preceding claims, wherein the appliance is a gooseneck kettle.

5. The appliance according to any one of the preceding claims, wherein the first sensor is a load cell.

6. The appliance of claim 5, further including a base for removably receiving the vessel.

7. The appliance of claim 6, wherein the load cell is located in the base such that the amount of substance in the chamber may be measured by the load cell when the vessel is removably received by the base.

8. The appliance of any one of claims 2 to 7, wherein the second sensor arrangement is an IMU.

9. The appliance of any one of claims 2 to 8, wherein the reference axis is horizontal, such that the second sensor arrangement measures the vessel's tilt from a vertical reference.

10. The appliance of any one of the preceding claims, wherein the chamber has a cylindrical shape.

11. The appliance of claim 10, wherein the target tilt (α_{T}) for a predetermined amount yr is calculated from
$$tan ( {α}_{T} ) = \frac{π {R}_{1}^{2} H + {y}_{T} - w ( 0 )}{π {R}_{1}^{2} ( X + {R}_{1} )}$$
where R₁ is the radius of the cylindrical chamber, H is the height of the cylindrical chamber, w(0) is the initial volume of substance determined from the parameter measure by the first sensor arrangement, and X is the horizontal displacement between an inlet and an outlet of a spout of the vessel.

12. The appliance of claim 10, wherein the target tilt (α_{T}) is calculated using a search algorithm to solve
$${α}_{T} = arg {min}_{0 < α < 90 °} \vert w ( α ) - w ( {α}_{T} ) \vert$$
where w(α) is the volume of substance in the kettle as a function of tilt (α).

13. The appliance of claim 12, wherein the volume of substance in the kettle as a function of tilt is determined by
$$w ( α ) = \{ \begin{matrix}π {R}_{1}^{2} {H}_{w} & , if α \leq {α}_{0} \\ \frac{1}{2} π {R}_{1}^{2} ( {u}_{1} ( α ) + {wu}_{2} ( α ) ) & , if {α}_{0} < α \leq {α}_{1} \\ \frac{1}{2} {u}_{2} ( α ) {R}_{1}^{2} ( π − \frac{1}{2} θ ( α ) + \frac{1}{2} sin ( θ ( α ) ) ) & , otherwise\end{matrix}$$
$$where$$
$${u}_{1} ( α ) = {}^{-} H - ( X + 2 {R}_{1} ) tan ( α )$$
$${u}_{2} ( α ) = H - ( X tan ( α )$$
$$cos ( \frac{θ ( α )}{2} ) = \frac{H}{{R}_{1} tan ( α )} - \frac{X}{{R}_{1}} - 1$$
$$tan ( {a}_{0} ) = \frac{H - {H}_{w}}{X + {R}_{1}}$$
$$tan ( {a}_{1} ) = \frac{H}{X + 2 {R}_{1}} .$$

14. The appliance according to any one of claims 11 to 13, wherein a target tilt rate (dα/dt) for a predetermined flowrate (dy/dt) is calculated from
$$\frac{d α}{d t} = \{ \begin{matrix}\frac{dy}{d t} \frac{{cos}^{2} ( α )}{π {R}_{1}^{2} ( X + {R}_{1} )} , & {α}_{0} < α \leq {α}_{1} \\ \frac{dy}{d t} \frac{2}{{R}_{1}^{2}} \frac{− 1}{z ( α ) \frac{d {u}_{2}}{d α} + {u}_{2} ( α ) \frac{dz}{d α}} , & α > {α}_{1}\end{matrix}$$
$$where$$
$$z ( α ) = π - \frac{1}{2} θ ( α ) + \frac{1}{2} sin ( θ ( α ) )$$
$$\frac{dz}{d α} = \frac{1}{2} \frac{d θ}{d α} ( cos ( θ ( α ) ) - 1 )$$
$$cos ( \frac{θ ( α )}{2} ) = \frac{H}{{R}_{1} tan ( a )} - \frac{X}{{R}_{1}} - 1$$
$$\frac{d θ}{d α} = \frac{2 H}{{R}_{1}} \frac{1}{{sin}^{2} ( α ) \sqrt{1 − {( \frac{H}{{R}_{1} tan ( α )} − \frac{X}{{R}_{1}} − 1 )}^{2}}}$$
$${u}_{2} ( α ) = H - X tan ( α )$$
$$\frac{{du}_{2}}{d α} = \frac{- X}{{cos}^{2} ( α )} .$$

15. The appliance of any one of claims 1 to 9, wherein the chamber has a frustoconical shape, and wherein the target tilt (α_{T}) for a predetermined amount yr is calculated using a search algorithm to solve
$${α}_{0} = arg {min}_{0 < α < {α}_{1}} \vert w ( α ) - w ( 0 ) \vert$$
$$where$$
$${α}_{1} = {tan}^{- 1} ( \frac{H}{X + 2 R} )$$
where w(α) is the volume of substance in the kettle as a function of tilt α, and α₁ is the maximum tilt where a base of the chamber is fully covered by substance.

16. The appliance of claim 15, wherein the volume of substance in the kettle as a function of tilt is determined by
$$w ( α ) = \frac{π {H}_{o}}{6 R} ( 2 {R}^{3} - {{r}_{1} ( α )}^{3} - {{r}_{2} ( α )}^{3} )$$
$$where {α}_{0} \leq α < {α}_{1} ,$$
$${r}_{1} ( α ) = R - \frac{H - ( X + 2 R ) tan ( α )}{\frac{{H}_{o}}{R} - tan ( α )}$$
$${r}_{2} ( α ) = R - \frac{H - X tan ( α )}{\frac{{H}_{o}}{R} + tan ( α )}$$
$${u}_{1} ( α ) = \frac{H - ( X + 2 R ) tan ( α )}{1 - \frac{R}{{H}_{o}} tan ( α )}$$
$${u}_{2} ( α ) = \frac{H - X tan ( α )}{1 + \frac{R}{{H}_{o}} tan ( α )}$$
$${α}_{1} = {tan}^{- 1} ( \frac{H}{X + 2 R} )$$
$${α}_{0} = arg {min}_{0 \leq α < {α}_{1}} \vert w ( α ) - w ( 0 ) \vert .$$

17. An appliance including:
a vessel having a chamber for containing flowable substance, the vessel including a sensor arrangement for measuring a tilt angle α of the vessel with respect to a reference plane;
a base for removably receiving the vessel, the base including a load cell for determining an initial amount of substance w(0) in the vessel received by the base;
a control unit that is in electrical communication with the sensor arrangement and the load cell, the control unit being configured to determine a target tilt angle α_{T} required to dispense a user selected amount of substance yr from the chamber based on the initial amount of substance w(0) and the vessel's physical dimensions.

18. The appliance of claim 17, further including an input device in electrical communication with the control unit for selecting the required amount of substance yr to be dispensed from the vessel.

19. The appliance of claim 17 or 18, further including a feedback device for guiding a user to meet the target tilt angle (α_{T}).

20. The appliance of claim 19 wherein the feedback device is an electronic display.

21. The appliance of claim 19, wherein the feed back device is haptic board.

22. The appliance of claim 19, wherein the feedback device is an audio device.

23. The appliance of any one of claims 19 to 22, wherein the feedback device has an intensity indicative of the deviation of the tilt angle measured by the sensor and the target tilt angle.

24. A method of using the appliance according to any one of claims 1-23, including the steps of:
measuring the amount of substance in the chamber
selecting a predetermined amount of substance to dispense from the vessel
determining the target tilt angle required to dispense the predetermined amount of substance
orientating the kettle into the target tilt angle and keeping the vessel in this position until substance substantially stops flowing.
